(19) United States
(12) Patent Application Publication
(10) Pub. No.: US 2023/0338854 A1
(43) Pub. Date: Oct. 26, 2023

(54) OBJECT PROCESSING METHOD AND APPARATUS IN VIRTUAL SCENE, DEVICE, AND STORAGE MEDIUM

(71) Applicant: TENCENT TECHNOLOGY (SHENZHEN) COMPANY LIMITED, Shenzhen (CN)

(72) Inventors: Yachang WANG, Shenzhen (CN); Yang YANG, Shenzhen (CN); Yulong WANG, Shenzhen (CN)

(21) Appl. No.: 18/343,051

(22) Filed: Jun. 28, 2023

Related U.S. Application Data
(63) Continuation of application No. PCT/CN2022/131771, filed on Nov. 14, 2022.

(30) Foreign Application Priority Data
Jan. 27, 2022 (CN) 202210102421.X

(51) Int. Cl. G06T 19/20; G06V 10/74; A63F 13/577; A63F 13/573

(52) U.S. Cl. CPC A63F 13/577; A63F 13/573; G06T 19/20; G06V 10/761; G06T 2219/2004; G06V 2201/07

(57) ABSTRACT

An object processing method in a virtual scene, includes: determining a field of view of an artificial intelligence (AI) object in the virtual scene; controlling the AI object to move in the virtual scene based on the field of view; performing collision detection of three-dimensional (3D) space on a virtual environment where the AI object is located during movement of the AI object to obtain a detection result; and controlling, in response to determining that an obstacle exists in a moving path of the AI object based on the detection result, the AI object to avoid the obstacle.

### CROSS-REFERENCES TO RELATED APPLICATIONS

This application is a continuation application of PCT Patent Application No. PCT/CN2022/131771, filed on Nov. 14, 2022, which claims priority to Chinese Patent Application No.202210102421.X with an application date of Jan. 27, 2022, the entire contents of both of which are incorporated herein by reference.

### FIELD OF THE TECHNOLOGY

The present disclosure relates to the technical field of virtualization and human-computer interaction, and in particular to, an object processing method and apparatus in a virtual scene, a device, a storage medium, and a program product.

### BACKGROUND

With rapid development of computer technology and Internet technology, electronic games, such as shooting games, tactical competitive games, and role-playing games, are increasingly popular. In the game process, a player’s experience in a three-dimensional (3D) open-world game is enhanced by giving an artificial intelligence (AI) object the ability to perceive the surrounding environment.

However, in related art, for the visual field perception capability of the AI object, there are problems such as improper field of view, resulting in the AI object colliding with a movable character in a game scene and causing a game picture to get stuck, and the AI object showing poor authenticity.

### SUMMARY

The embodiments of the present disclosure provide an object processing method and apparatus in a virtual scene, a device, a computer-readable storage medium, and a computer program product, which may achieve the flexibility of the AI object when avoiding obstacles in the virtual scene, make the performance of the AI object more real, and improve the object processing efficiency in the virtual scene.

The technical solutions of the embodiments of the present disclosure are implemented as follows:

The embodiments of the present disclosure provide an object processing method in a virtual scene executed by an electronic device, including: determining a field of view of an AI object in the virtual scene; controlling the AI object to move in the virtual scene based on the field of view; performing collision detection of 3D space on a virtual environment where the AI object is located during movement of the AI object to obtain a detection result; and controlling, in response to determining that an obstacle exists in a moving path of the AI object based on the detection result, the AI object to avoid the obstacle.

The embodiments of the present disclosure provide an object processing apparatus in a virtual scene, including: a determination module, configured to determine a field of view of an AI object in the virtual scene; a first control module, configured to control the AI object to move in the virtual scene based on the field of view; a detection module, configured to perform collision detection of 3D space on a virtual environment where the AI object is located during movement of the AI object to obtain a detection result; and a second control module, configured to control, in response to determining that an obstacle exists in a moving path of the AI object based on the detection result, the AI object to avoid the obstacle.

The embodiments of the present disclosure provide an electronic device, including: at least one memory, configured to store executable instructions; and at least one processor, configured to implement, in executing the executable instructions stored in the at least one memory, the object processing method in a virtual scene provided by the embodiments of the present disclosure.

The embodiments of the present disclosure provide a non-transitory computer-readable storage medium storing executable instructions configured to, when executed by at least one processor, implement the object processing method in a virtual scene provided by the embodiments of the present disclosure.

The embodiments of the present disclosure have the following beneficial effects:

The application of the above embodiments of the present disclosure gives the AI object an anthropomorphic field of view in the virtual scene, and controls the movement of the AI object in the virtual scene according to the field of view to realize the anthropomorphic field of view of the AI object, so that the performance of the AI object in the virtual scene is more authentic. In addition, the collision detection of the virtual environment can effectively control the AI objects to execute flexible and effective obstacle avoidance behaviors, and improve the object processing efficiency in the virtual scene. At the same time, by giving the AI object the visual field perception capability and combining with the collision detection, the AI object can smoothly avoid obstacles in the virtual scene, avoiding the situation that the AI object collides with the movable character to make the picture stuck in the related art, and reducing the hardware resource consumption when the picture is stuck.

### BRIEF DESCRIPTION OF THE DRAWINGS

FIG. 1 is an architectural diagram of an object processing system 100 in a virtual scene provided by an embodiment of the present disclosure.

FIG. 2 is a structural diagram of an electronic device 500 implementing an object processing method in a virtual scene provided by an embodiment of the present disclosure.

FIG. 3 is a flow diagram of an object processing method in a virtual scene provided by an embodiment of the present disclosure.

FIG. 4 is a flowchart of a method for determining a field of view of an AI object provided by an embodiment of the present disclosure.

FIG. 5 is a diagram of a field of view of an AI object provided by an embodiment of the present disclosure.

FIG. 6 is a diagram of a method for determining a perception region of an AI object provided by an embodiment of the present disclosure.

FIG. 7 is a diagram of a perception region of an AI object provided by an embodiment of the present disclosure.

FIG. 8 is a diagram of a method for dynamically adjusting perception degree of an AI object provided by an embodiment of the present disclosure.

FIG. 9 is a diagram of a manner of an AI object being kept away from a virtual object provided by an embodiment of the present disclosure.

FIG. 10 is a diagram of an escape region of an AI object provided by an embodiment of the present disclosure.

FIG. 11 is a diagram of a mesh polygon of an escape region provided by an embodiment of the present disclosure.

FIG. 12 is a diagram of obstacle occlusion detection in a virtual scene provided by an embodiment of the present disclosure.

FIG. 13 is a diagram of an obstacle detection method in a virtual scene provided by an embodiment of the present disclosure.

FIG. 14 is a diagram of voxelization of a virtual scene provided by the related art.

FIG. 15 is a diagram of visual field perception of an AI object provided by an embodiment of the present disclosure.

FIG. 16 is a diagram of AI object pathfinding provided by an embodiment of the present disclosure.

FIG. 17 is a diagram of changes in a field of view of an AI object provided by an embodiment of the present disclosure.

FIG. 18 is a diagram of PhysX simulation results provided by an example of the present disclosure.

FIG. 19 is a diagram illustrating movement of AI objects to block each other provided by an embodiment of the present disclosure.

FIG. 20 is a flowchart for generating a navigation mesh (navmesh) corresponding to a virtual scene provided by an embodiment of the present disclosure.

FIG. 21 is a diagram of a navmesh provided by an embodiment of the present disclosure.

FIG. 22 is a flow diagram of a method for selecting points in a region provided by an embodiment of the present disclosure.

FIG. 23 is a diagram of controlling an AI object to perform escape operations provided by an embodiment of the present disclosure.

FIG. 24 is a diagram of performance of an AI object provided by an embodiment of the present disclosure.

### DESCRIPTION OF EMBODIMENTS

To make the objectives, technical solutions, and advantages of the present disclosure clearer, the following describes the present disclosure in detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all possible embodiments, but it may be understood that “some embodiments” may be the same subset or different subsets of all the possible embodiments, and may be combined with each other without conflict.

The following description is added if a similar description of “first/second” appears in the specification. In the following description, the terms “first, second, and third” are merely intended to distinguish similar objects and do not represent a particular ordering of the objects. It may be understood that the terms “first, second, and third” may be interchanged either in a particular order or in a sequential order, as permitted, to enable the embodiments of the present disclosure described herein to be implemented other than that illustrated or described herein.

Unless otherwise defined, meanings of all technical and scientific terms used in this specification are the same as those usually understood by a person skilled in the art to which the present disclosure belongs. The terms used herein are for the purpose of describing the embodiments of the present disclosure only and are not intended to limit the present disclosure.

Before the embodiments of the present disclosure are described in detail, a description is made on nouns and terms in the embodiments of the present disclosure, and the nouns and terms in the embodiments of the present disclosure are applicable to the following explanations.

(1) A virtual scene is one that an application (APP) displays (or provides) when running on a terminal. The virtual scene may be a purely fictitious virtual environment. The virtual scene may be any one of a two-dimensional (2D) virtual scene, a 2.5-dimensional (2.5D) virtual scene, or a 3D virtual scene; and the dimensions of the virtual scene are not limited in the embodiments of the present disclosure. For example, the virtual scene may include a sky, a land, a sea, and the like. The land may include an environmental element such as a desert, a city, and the like. A user may control the virtual object to perform an activity in the virtual scene, the activity including but not limited to at least one of adjusting body postures, crawling, walking, running, riding, jumping, driving, picking up, shooting, attacking, and throwing. The virtual scene may be displayed from a first-person perspective (for example, to play a virtual object in a game in a player’s own perspective). The virtual scene may also be displayed from a third-person perspective (for example, the player follows the virtual object in a game to play the game). The virtual scene may further be displayed in a large perspective of bird’s eye view. The above perspectives may be arbitrarily switched.

Taking displaying the virtual scene from a first-person perspective as an example, the virtual scene displayed in a human-computer interaction interface may include: determining a visual field region of the virtual object according to a viewing position and a visual field angle of the virtual object in the complete virtual scene, and presenting a part of the virtual scene located in the visual field region in the complete virtual scene, namely, the displayed virtual scene may be a part of the virtual scene relative to the panoramic virtual scene. Since the first-person perspective is the viewing angle most capable of giving the user an impact force, in this way, an immersive perception of the user’s presence during operation may be achieved. Taking displaying the virtual scene from a large perspective of bird’s eye view as an example, the interface of the virtual scene presented in the human-computer interaction interface may include: presenting, in response to a zoom operation for the panoramic virtual scene, a part of the virtual scene corresponding to the zoom operation in the human-computer interaction interface, that is, the displayed virtual scene may be a part of the virtual scene relative to the panoramic virtual scene. In this way, the operability of the user during the operation may be improved, so that the efficiency of the human-computer interaction may be improved.

(2) A virtual object can be representations of various people and things that can interact in a virtual scene, or an inactive object in the virtual scene. The virtual object may be movable and may be a virtual character, a virtual animal, an animated character, and the like, such as a character, an animal, a plant, an oil bucket, a wall, and a stone, displayed in the virtual scene. The virtual object may be a virtual avatar in the virtual scene for representing a user. A plurality of virtual objects may be included in the virtual scene, each virtual object having its own shape and volume in the virtual scene and occupying a part of the space in the virtual scene.

For example, the virtual object may be a user role controlled by an operation on a client, an AI object set in a virtual scene battle by training, or a non-player character (NPC) set in a virtual scene interaction. For example, the virtual object may be a virtual character that makes an antagonistic interaction in the virtual scene. For example, the number of virtual objects participating in the interaction in the virtual scene may be preset or dynamically determined according to the number of clients participating in the interaction.

Taking a shooting game as an example, the user may control the virtual object to freely fall, glide, or open a parachute to fall, and the like in the sky of the virtual scene, and to run, jump, crawl, bend forward, and the like on land, and may also control the virtual object to swim, float or dive, and the like in the sea. Of course, the user may also control the virtual object to move in the virtual scene by a vehicle-type virtual prop, for example, the vehicle-type virtual prop may be a virtual automobile, a virtual aircraft, or a virtual yacht. The user may also control the virtual object to perform antagonistic interaction with other virtual objects via an attack-type virtual prop, for example, the virtual prop may be a virtual mecha, a virtual tank, and a virtual fighter, which is merely illustrated in the above scenes and is not limited in the embodiments of the present disclosure.

(3) Scene data represents various features to which an object in the virtual scene is subjected during interaction, and may include, for example, the position of the object in the virtual scene. Of course, different types of features may be included according to the types of the virtual scene. For example, in a virtual scene of a game, scene data may include the time required to wait for various functions configured in the virtual scene (depending on the number of times the same function may be used within a particular time), and may also represent attribute values for various states of the game character, including, for example, a life value (also referred to as a red amount), a magic value (also referred to as a blue amount), a state value, and a blood amount.

(4) A physical calculation engine makes the movement of objects in the virtual world conform to the physical laws of the real world to make the game more realistic. The physical engine may use object properties (momentum, torque, or elasticity) to simulate rigid body behavior with more realistic results, allowing complex mechanical apparatuses like spherical joints, wheels, cylinders, or hinges. Some also support physical attributes of non-rigid bodies, such as fluids. The physical engine is divided by technical classification, including PhysX engine, Havok engine, Bullet engine, Unreal engine (UE), Unity engine, and the like.

The PhysX engine is a physical calculation engine, which may be calculated by central processing unit (CPU), but the program itself may also be designed to call independent floating-point processors (such as graphics processing unit (GPU) and picture processing unit (PPU)) to calculate. As such, the PhysX engine may perform physical simulation calculation of a large amount of calculation like fluid mechanics simulation, and may make the movement of objects in the virtual world conform to the physical laws of the real world, to make the game more realistic.

(5) Collision query is a way to detect a collision, including sweep, raycast, and overlap. The sweep detects the collision by performing a scanning query of a specified geometric body within a specified distance from a specified starting point in a specified direction. The raycast detects the collision by performing a volume-free ray query within a specified distance from a specified starting point in a specified direction. The overlap detects the collision by determining whether a specified geometry is involved in a collision.

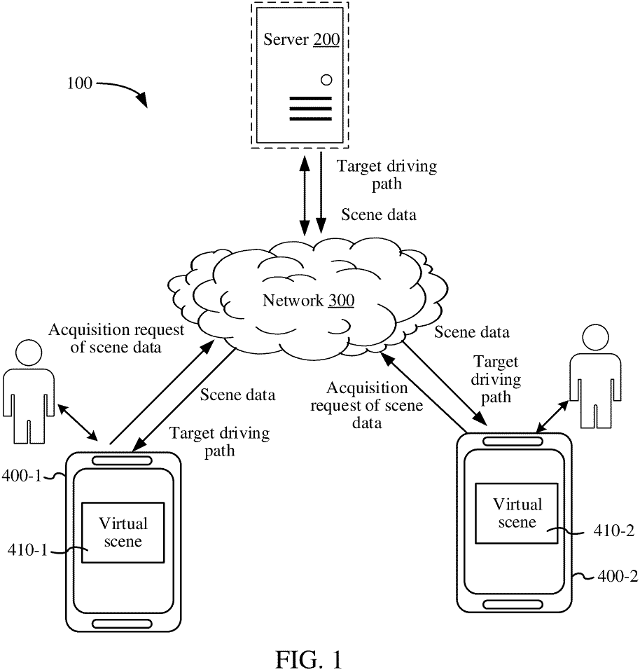

Based on the above explanations of the nouns and terms involved in the embodiments of the present disclosure, the following describes the object processing system in the virtual scene provided by the embodiments of the present disclosure. Referring to FIG. 1, FIG. 1 is an architectural diagram of an object processing system 100 in a virtual scene provided by an embodiment of the present disclosure. In order to support an exemplary application, a terminal (a terminal 400-1 and a terminal 400-2 are illustratively shown) is connected to a server 200 via a network 300; the network 300 may be a wide area network or a local area network, or a combination of both, and data transmission is realized using a wireless or wired link.

The terminal (such as a terminal 400-1 and a terminal 400-2) is configured to receive a trigger operation of entering the virtual scene based on a view interface and send an acquisition request of scene data of the virtual scene to the server 200.

The server 200 is configured to receive an acquisition request of scene data, and return the scene data of the virtual scene to the terminal in response to the acquisition request.

The server 200 is further configured to: determine a field of view of an AI object in a virtual scene created by a 3D physical simulation; control the AI object to move in the virtual scene based on the field of view; perform collision detection of 3D space on a virtual environment where the AI object is located during movement of the AI object to obtain a detection result; and control, in response to determining that an obstacle exists in a moving path of the AI object based on the detection result, the AI object to avoid the obstacle.

The terminal (such as a terminal 400-1 and a terminal 400-2) is configured to receive scene data of the virtual scene, render a picture of the virtual scene based on the obtained scene data, and present the picture of the virtual scene on a graphic interface (illustratively showing a graphic interface 410-1 and a graphic interface 410-2). An AI object, a virtual object, an interaction environment, and the like may also be presented in the picture of the virtual scene, and the contents of the picture presentation of the virtual scene are rendered based on the returned scene data of the virtual scene.

In actual application, the server 200 may be an independent physical server, may also be a server cluster or distributed system composed of a plurality of physical servers, and may also be a cloud server providing basic cloud computing services such as a cloud service, a cloud database, cloud computing, a cloud function, cloud storage, a network service, cloud communication, a middleware service, a domain name service, a security service, a content delivery network (CDN), and a large data and AI platform. The terminal (for example, a terminal 400-1 and a terminal 400-2) may be, but is not limited to, a smartphone, a tablet, a laptop, a desktop computer, a smart speaker, a smart television, a smartwatch, and the like. The terminal (for example, a terminal 400-1 and a terminal 400-2) and the server 200 may be directly or indirectly connected through wired or wireless communication, which is not limited in the present disclosure.

In actual application, the terminal (including the terminal 400-1 and the terminal 400-2) installs and runs an APP supporting the virtual scene. The APP may be any one of a first-person shooting (FPS) game, a third-person shooting game, a driving game with a steering operation as a dominant action, a multiplayer online battle arena (MOBA) game, a 2D game application, a 3D game application, a virtual reality APP, a 3D map program, or a multiplayer gunfight survival game. The APP may also be a stand-alone one, such as a stand-alone 3D game program.

Taking an electronic game scene as an exemplary scene, the user may perform an operation on the terminal in advance; after detecting the user’s operation, the terminal may download a game configuration file of an electronic game, and the game configuration file may include an APP, interface display data, or virtual scene data, and the like of the electronic game, so that the user may call, when logging in the electronic game on the terminal, the game configuration file to render and display an electronic game interface. The user may perform a touch operation on the terminal; and after detecting the touch operation, the terminal may determine game data corresponding to the touch operation and render and display the game data. The game data may include virtual scene data, behavioral data of a virtual object in the virtual scene, and the like.

In actual application, the terminal (including a terminal 400-1 and a terminal 400-2) receives a trigger operation of entering the virtual scene based on a view interface, and sends an acquisition request of scene data of the virtual scene to the server 200. The server 200 receives an acquisition request of scene data, and returns the scene data of the virtual scene to the terminal in response to the acquisition request. The terminal receives the scene data of the virtual scene, renders a picture of the virtual scene based on the scene data, and presents at least one AI object and a virtual object controlled by a player in an interface of the virtual scene.

The embodiments of the present disclosure may be implemented through cloud technology, which refers to a hosting technology for unifying a series of resources, such as hardware, software, and a network, in a wide area network or a local area network to realize the calculation, storage, processing, and sharing of data.

Cloud technology is a general term for network technology, information technology, integration technology, management platform technology, and application technology based on cloud computing business model application, which can form a resource pool and be used on demand with flexibility and convenience. Cloud computing technology will become an important support. Background services of technical network systems require a large amount of computing and storage resources.

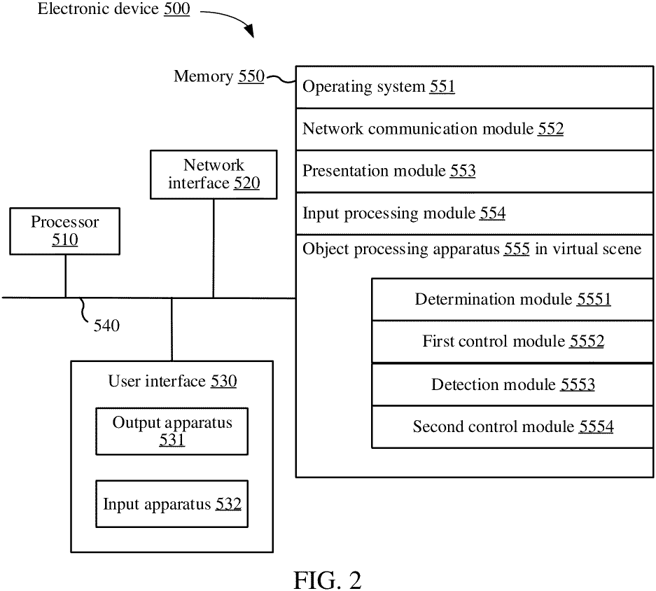

Referring to FIG. 2, FIG. 2 is a structural diagram of an electronic device 500 implementing an object processing method in a virtual scene provided by an embodiment of the present disclosure. In actual application, the electronic device 500 may be a server or a terminal shown in FIG. 1. Taking the electronic device 500 as the terminal shown in FIG. 1 as an example, the electronic device implementing the object processing method in the virtual scene of an embodiment of the present disclosure is illustrated. The electronic device 500 provided by the embodiments of the present disclosure includes at least one processor 510, a memory 550, at least one network interface 520, and a user interface 530. The various assemblies in the electronic device 500 are coupled together by a bus system 540. It may be understood that, the bus system 540 is configured to implement connection communication between the assemblies. The bus system 540 includes a power bus, a control bus, and a status signal bus in addition to a data bus. However, for the sake of clarity, the various buses are labeled as the bus system 540 in FIG. 2.

The processor 510 may be an integrated circuit chip with signal processing capabilities, such as a general-purpose processor, a digital signal processor (DSP), or other programmable logic devices, discrete gate or transistor logic devices, and discrete hardware assemblies; the general-purpose processor may be a microprocessor or any proper processor, and the like.

The user interface 530 includes one or more output apparatuses 531 enabling the presentation of media content, including one or more speakers and/or one or more visual display screens. The user interface 530 further includes one or more input apparatuses 532, including user interface components that facilitate user input, such as a keyboard, mouse, microphone, touch-screen display screen, camera, other input buttons, and controls.

The memory 550 may be removable, non-removable, or a combination thereof. Exemplary hardware devices include solid state memories, hard disk drives, optical disk drives, and the like. The memory 550 may include one or more storage devices physically located remotely from the processor 510.

The memory 550 includes a volatile memory or a non-volatile memory, and may include both volatile and non-volatile memories. The non-volatile memory may be a read-only memory (ROM), and the volatile memory may be a random-access memory (RAM). The memory 550 described in the embodiments of the present disclosure is intended to include any suitable type of memory.

In some embodiments, the memory 550 can store data to support various operations; and the examples of the data include programs, modules, and data structures, or subsets or supersets thereof, as exemplified below.

An operating system 551 includes system programs configured to process various basic services and perform hardware-related tasks, such as a framework layer, a core library layer, and a driver layer, for implementing various basic system services and processing hardware-related tasks.

A network communication module 552 is configured to reach other electronic devices via one or more (wired or wireless) network interfaces 520. An exemplary network interface 520 includes Bluetooth, WiFi, a universal serial bus (USB), and the like.

A presentation module 553 is configured to enable presentation of information (for example, a user interface for operating peripheral devices and displaying contents and information) via one or more output apparatuses 531 (for example, a display screen and a speaker) associated with the user interface 530.

An input processing module 554 is configured to detect one or more user inputs or interactions from one of the one or more input apparatuses 532 and translate the detected inputs or interactions.

In some embodiments, the object processing apparatus in the virtual scene provided by the embodiments of the present disclosure may be implemented in a software manner. FIG. 2 shows an object processing apparatus 555 stored in a virtual scene in a memory 550, which may be software in the form of a program, a plug-in, and the like, including the following software modules: a determination module 5551, a first control module 5552, a detection module 5553 and a second control module 5554, these modules being logical and being able to be combined or split arbitrarily according to the functions implemented. The functions of the various modules will be described hereinafter.

In other embodiments, the object processing apparatus in the virtual scene provided by the embodiments of the present disclosure may be implemented by a combination of hardware and software. As an example, the object processing apparatus in the virtual scene provided by the embodiments of the present disclosure may be a processor in the form of a hardware decoding processor which is programmed to execute the object processing method in the virtual scene provided by the embodiments of the present disclosure. For example, the processor in the form of the hardware decoding processor may use one or more application specific integrated circuits (ASIC), DSP, programmable logic device (PLD), complex programmable logic device (CPLD), field-programmable gate array (FPGA), or other electronic elements.

Based on the above illustration of the object processing system in the virtual scene and the electronic device provided by the embodiments of the present disclosure, the object processing method in the virtual scene, provided by the embodiments of the present disclosure, is illustrated below. In some embodiments, the object processing method in the virtual scene provided by the embodiments of the present disclosure may be implemented by a server or a terminal alone, or by the server and the terminal in cooperation. In some embodiments, the terminal or the server may implement the object processing method in the virtual scene provided by the embodiments of the present disclosure by running a computer program. For example, the computer program may be a native program or a software module in an operating system. It may be a local APP, namely, a program that needs to be installed in the operating system to run, such as a client supporting the virtual scene, such as a game APP. It may be an applet, namely, a program that only needs to be downloaded to the browser environment to run. It may also be an applet that may be embedded in any APP. In general, the above computer programs may be any form of APP, module, or plug-in.

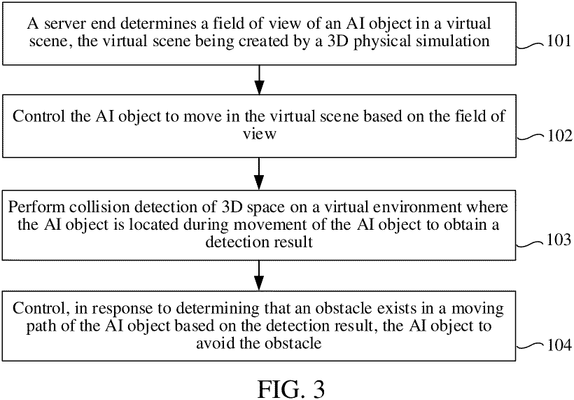

The object processing method in the virtual scene provided by the embodiments of the present disclosure is illustrated below taking a server implementation as an example. Referring to FIG. 3, FIG. 3 is a flow diagram of an object processing method in a virtual scene provided by an embodiment of the present disclosure. The object processing method in the virtual scene, provided by the embodiment of the present disclosure, includes the following steps:

Step 101: A server determines a field of view of an AI object in a virtual scene.

The virtual scene may be created by a 3D physical simulation. In actual implementation, the server receives a creation request for the virtual scene triggered when the terminal runs an application client supporting the virtual scene; the server acquires configuration information used for configuring the virtual scene, and downloads a physical engine from a cloud end or acquires the physical engine from a preset memory. The physical engine may be a PhysX engine, thus capable of performing physical simulation on a 3D open world and accurately restoring a real virtual scene, giving the AI object a physical perception capability on the 3D world. Based on the configuration information, a virtual scene is created through 3D physical simulation; and a physical engine is used to give physical attributes objects in the virtual scene, such as a river, stone, wall, grass, tree, tower, and building. Virtual objects and objects in the virtual scene may use corresponding physical attributes to simulate rigid body behaviors (simulate the laws of motion of various objects in the real world to move), so that the created virtual scene has a more realistic visual effect. The AI object may be presented in the virtual scene, as well as the virtual object is controlled by a player. When the AI object moves in the virtual scene, the server may determine a moving region of the AI object by acquiring a field of view of the AI object, and control the AI object to move in the corresponding moving region.

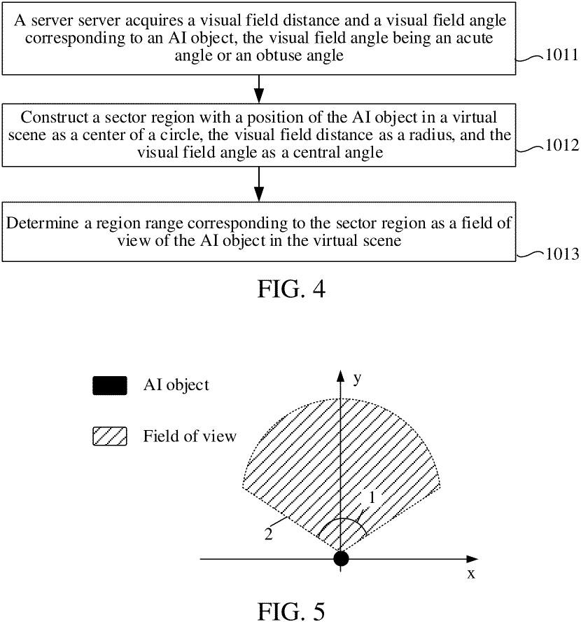

The method for determining the field of view of the AI object in the virtual scene is described. In some embodiments, referring to FIG. 4, FIG. 4 is a flowchart of a method for determining a field of view of an AI object provided by an embodiment of the present disclosure. Based on FIG. 3, step 101 may be implemented by steps 1011 to 1013, illustrated in conjunction with the steps shown in FIG. 4.

Step 1011: The server acquires a visual field distance and a visual field angle corresponding to the AI object, the visual field angle being an acute angle or an obtuse angle.

In actual implementation, the server end gives the AI object an anthropomorphic field of view, so that the AI object can perceive the surrounding virtual environment, and such an AI object performs more realistically. Under normal conditions, when the field of view of the AI object is open, the visual field distance of the AI object is not infinite; the far-distance field of view is invisible, and the near-distance field of view is visible. The field of view of the AI object is not 360°, the field of view of the front side of the AI object is visible (namely, the field of view), while the field of view of the back side of the AI object is invisible (namely, the field of view blind zone), but may have a basic anthropomorphic perception at this time. In addition, the field of view of the AI object is not to be perspective, and the field of view behind the obstacle is invisible. When the field of view of the AI object is off, there is no field of view.

Referring to FIG. 5, FIG. 5 is a diagram of a field of view of an AI object provided by an embodiment of the present disclosure; the field of view of the AI object may be controlled by two parameters, namely, a visual field distance (the length of a line segment shown by number 2 in the drawing is used for representing the visual field distance of the AI object) and a visual field angle (the included angle shown by number 1 in the drawing). These two parameters may be set manually according to the actual game application. The parameter setting information may only ensure the anthropomorphic requirements of near-distance visibility, far-distance invisibility, front-view visibility, and back-view invisibility. The setting of the visual field angle may take the position where the AI object is located as the origin, the forward direction of the AI object as the y-axis direction, and the direction perpendicular to the forward direction as the x-axis direction, and set a corresponding coordinate system (the type of the coordinate system is not limited) to determine the visual field angle. In order to make the representation of the AI object more realistic, the visual field angle is an acute angle or an obtuse angle.

Step 1012: Construct a sector region with a position of the AI object in the virtual scene as a center of a circle, the visual field distance as a radius, and the visual field angle as a central angle.

In actual implementation, the human field of view is a sector region; to realistically simulate the human field of view, the sector region used as the field of view may be constructed based on the position the AI object is located, the visual field distance, and the visual field angle. Referring to FIG. 5, the service end determines the sector region with the position where the AI object is located as the center, the visual field distance as the radius, and the visual field angle as the central angle.

Step 1013: Determine a region range corresponding to the sector region as the field of view of the AI object in the virtual scene.

In actual implementation, referring to FIG. 5, the server end uses the sector region in the drawing as a field of view (also referred to as a visible region) of the AI object; objects within the field of view and without being blocked by an obstacle are visible to the AI object; and objects outside the field of view are invisible to the AI object.

In some embodiments, the server may also adjust the field of view of the AI object in the virtual scene according to the following manners: The server acquires a current light environment of a virtual environment where the AI object is located, brightness of different light environments varying from one to another. The field of view of the AI object in the virtual scene is correspondingly adjusted during the movement of the AI object in response to that the current light environment changes, a range of the field of view being positively correlated with the brightness of the current light environment, that is, the greater the brightness of the light environments are, the greater the field of view of the AI object is.

In actual application, there may be a linear mapping relationship between the brightness of the light environments and the field of view; the linear coefficient of the linear mapping relationship is a positive number, and the size of the value may be set according to practical requirements. Based on the linear mapping relationship, the brightness of the light environments is mapped to obtain the field of view of the AI object in the virtual scene.

In actual implementation, to make the visual field perception performance of the AI object more realistic, the server may collect the light environments of the virtual environment the AI object located in real time or periodically, the brightness of different light environments being different. That is, the field of view of the AI object will change dynamically with the light environments in the virtual scene, for example, when the virtual environment is daytime, the field of view of the AI object is large; and when the virtual environment is nighttime, the field of view of the AI object is small. Therefore, the server may dynamically adjust the field of view of the AI object according to the current light environment of the virtual environment where the AI object is located, the light environment being affected by parameters such as brightness and light intensity. The field of view of the AI object varies with the brightness and light intensity of different light environments. The range of the field of view of the AI object is positively correlated with the brightness of the light environments of the present virtual environment, that is, the field of view of the AI object becomes larger as the brightness of the light environment increases and becomes smaller as the brightness of the light environment decreases. There may be a linear relationship between the brightness of the light environments and the field of view of the AI object, represented by the value of the brightness. In addition, the brightness of the light environment may be represented by an interval range that characterizes levels of the brightness. When the brightness is within the interval range corresponding to the corresponding level of the brightness, the server adjusts the field of view of the AI object to the field of view corresponding to the level of the brightness.

Illustratively, when the virtual environment in which the AI object is located is daytime, the brightness of the light environment is high and the light intensity is strong, the field of view of the AI object is set to be large; as the night comes in the virtual environment, the brightness of the light environment and the light intensity decrease, and the field of view of the AI object becomes smaller.

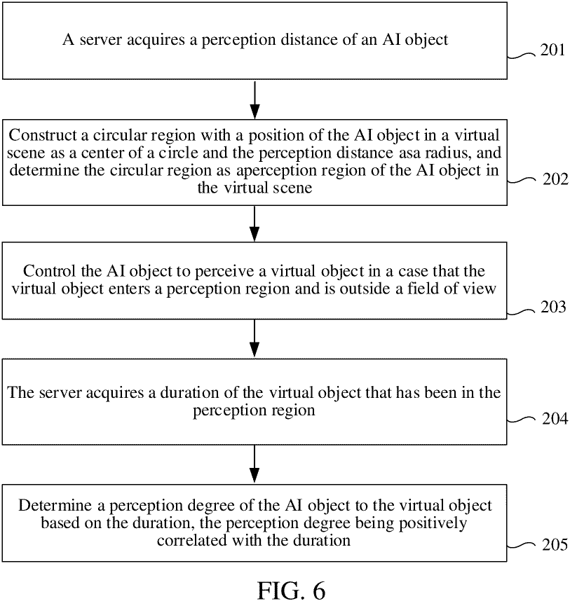

In some embodiments, referring to FIG. 6, FIG. 6 is a diagram of a method for determining a perception region of an AI object provided by an embodiment of the present disclosure, which is illustrated in conjunction with the steps shown in FIG. 6.

Step 201: The server acquires a perception distance of the AI object.

In actual implementation, other virtual objects (for example, players) that are outside the field of view of the AI object are invisible, but may be perceived by the AI object. The server may realize the perception of the AI object to other virtual objects by determining the perception region of the AI object to give the AI object an anthropomorphic perception operation. The determination of the perception region of the AI object is related to the perception distance of the AI object. The server determines the distance between the other virtual objects and the AI object outside the field of view of the AI object as an actual distance; when the actual distance is equal to or less than a preset perception distance of the AI object, the AI object can perceive the other virtual objects at this moment.

Step 202: Construct a circular region with a position of the AI object in the virtual scene as a center of a circle and the perception distance as a radius, and determine the circular region as a perception region of the AI object in the virtual scene.

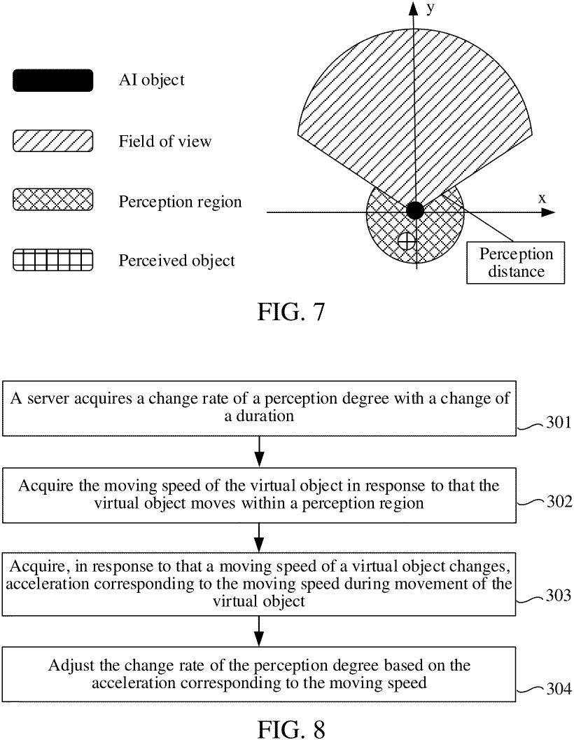

In actual implementation, the server may determine a circular region with the position of the AI object in the virtual scene as the center and the perception distance as the radius as the perception region of the AI object; the AI object can perceive an object when the object is outside the field of view of the AI object but within the perception region of the AI object. Referring to FIG. 7, FIG. 7 is a diagram of a perception region of an AI object provided by an embodiment of the present disclosure. When the field of view of the AI object is open, the perception region of the AI object is a partial circular region (a circular region not including the field of view) which does not coincide with the field of view of the AI object in the drawing; and when the field of view of the AI object is closed, the perception region of the AI object is the entire circular region (a circular region including the field of view) in the drawing.

Step 203: Control the AI object to perceive a virtual object in response to that the virtual object enters the perception region and is outside the field of view.

In actual implementation, when the virtual object is outside the field of view of the AI object, but enters the perception region of the AI object, the server controls the AI object to be able to perceive the virtual object in the perception region.

It should be noted that even when the AI object can perceive the virtual object in the perception region, the perception degree of the AI object to the virtual object is different. The perception degree of the AI object is related to the distance between the virtual object and the AI object, the duration of the virtual object in the perception region, and the movement of the virtual object.

In some embodiments, the server may also perform steps 204 to 205 to determine the perception degree of the AI object to the virtual object.

Step 204: The server acquires a duration that the virtual object has been in the perception region.

In actual implementation, the duration that the virtual object has been in the perception region may directly affect the perception degree of the AI object to the virtual object. The server starts timing when the virtual object enters the perception region to acquire the duration that the virtual object has been in the perception region.

Step 205: Determine a perception degree of the AI object to the virtual object based on the duration that the virtual object has been in the perception region, the perception degree being positively correlated with the duration.

When the longer the duration of the virtual object being within the perception region is, the stronger the perception degree of a corresponding AI object to the virtual object is. In actual application, there may be a linear mapping relationship between the perception degree of the AI object and the duration of entering the perception region; based on the linear mapping relationship, the duration of the virtual object entering the perception region is mapped to obtain the perception degree of the AI object to the virtual object. It should be noted that the perception degree of the AI object to the virtual object is positively correlated with the duration of the virtual object entering the perception region, that is, the longer the virtual object enters the perception region (the longer the duration is), the stronger the perception degree of the AI object to the virtual object is.

Illustratively, the server presets the initial value of the perception degree of the AI object to be 0; as time increases, the perception degree increases at a rate of 1 per second, that is, when the AI object perceives the virtual object, the perception degree is 0, and for every 1 second increase in the duration of the virtual object entering the perception region, the perception degree increases by 1.

In some embodiments, referring to FIG. 8, FIG. 8 is a diagram of a method for dynamically adjusting perception degree of an AI object provided by an embodiment of the present disclosure. The server may perform steps 301 to 304 to dynamically adjust the perception degree of the AI object to the virtual object after performing step 205, that is, determining the perception degree of the AI object to the virtual object.

Step 301: The server acquires a change rate of the perception degree with respect to a change of the duration.

In actual implementation, the perception degree of the AI object to the virtual object is also related to the movement of the virtual object within the perception region. The server obtains the change rate of the perception degree of the AI object changing with the duration, for example, perception degree increases by 1 per second.

Step 302: Acquire a moving speed of the virtual object in response to that the virtual object moves within the perception region.

In actual implementation, the faster the virtual object moves within the perception region, the faster the change of perception degree of the AI object is, for example, based on the increase of the duration, the perception degree increases at a rate of 1 per second; as the virtual object moves within the perception region, the perception degree changes, and may increase at a rate of 5 per second and 10 per second.

Step 303: Acquire, in response to that the moving speed of the virtual object changes, acceleration corresponding to the moving speed during movement of the virtual object.

In actual implementation, when the virtual object moves at a constant speed within the perception region, the perception degree increases by a fixed size every second. When the virtual object moves at a variable speed within the perception region, the server acquires the acceleration corresponding to the current moving speed.

Step 304: Adjust the change rate of the perception degree based on the acceleration corresponding to the moving speed.

In actual implementation, when the virtual object moves at a variable speed within the perception region, the server adjusts the change rate of the perception degree of the AI object according to a preset relationship between the acceleration and the change rate of the perception degree.

Illustratively, when the AI object is stationary in the perception region, the change rate of the perception degree of the AI object is 1 per second; when the AI object moves at a constant speed in the perception region, the change rate of the perception degree of the AI object is 5 per second; when the AI object moves at a variable speed in the perception region, the acceleration of the AI object at each moment is acquired, and the change rate of the perception degree of the AI object is determined according to a preset relationship between the acceleration and the change rate of the perception degree of the AI object; the sum of the acceleration and the preset change rate when moving at a constant speed may be directly taken as the change rate of the perception degree of the AI object. For example, at time t, the acceleration is 3, and the preset change rate when moving at a constant speed is 5 per second, then the change rate of the perception degree is set as 8. The embodiments of the present disclosure do not limit the relationship between the acceleration and the change rate of the perception degree of the AI object.

In some embodiments, the server may determine the perception degree of the AI object to the virtual object in the perception region according to the following manners: The server acquires a duration that the virtual object has been in the perception region, and determines a first perception degree of the AI object to the virtual object based on the duration. The server acquires a moving speed of the virtual object within the perception region, and determines a second perception degree of the AI object to the virtual object based on the moving speed. The server acquires a first weight corresponding to the first perception degree and a second weight corresponding to the second perception degree. The server obtains a weighted sum of the first perception degree and the second perception degree based on the first weight and the second weight, to obtain a target perception degree of the AI object to the virtual object.

In actual implementation, the perception degree of the AI object increases with the time that the virtual object performs the perception region. Meanwhile, the faster the moving speed of the virtual object in the perception region of the AI object is, the stronger the perception degree of the AI object is. That is, the perception degree of the AI object to the virtual object is influenced by at least two parameters, namely, the duration of the virtual object entering the perception region and the moving speed of the virtual object itself when moving within the perception region. The server may weight and sum a first perception degree, determined according to the duration of the perception region, and a second perception degree, determined according to the change of the moving speed of the virtual object, to obtain a final perception degree (target perception degree) of the AI object to the virtual object.

Illustratively, the first perception degree of the AI object is determined to be level A according to the duration the virtual object entering the perception region; and the second perception degree of the AI object is determined to be level B according to the moving speed of the virtual object in the perception region. A first weight a corresponding to the first perception degree is determined according to a preset duration parameter, and a second weight b corresponding to the second perception degree is determined according to a moving speed parameter, and the final perception degree of the AI object relative to the virtual object is obtained by summing level A and level B (the target perception degree=axA+b×B).

In some embodiments, the server may determine the perception degree of the AI object to the virtual object according to the following manners: The server acquires a distance between the virtual object and the AI object in the perception region. The server determines a perception degree of the AI object to the virtual object based on the distance, the perception degree being positively correlated with the distance.

In actual implementation, the server may also determine the perception degree of the AI object to the virtual object only according to the distance between the virtual object and the AI object; at this time, the perception degree is positively correlated with the distance, namely, the closer the distance between the virtual object and the AI object is, the stronger the perception degree of the AI object is.

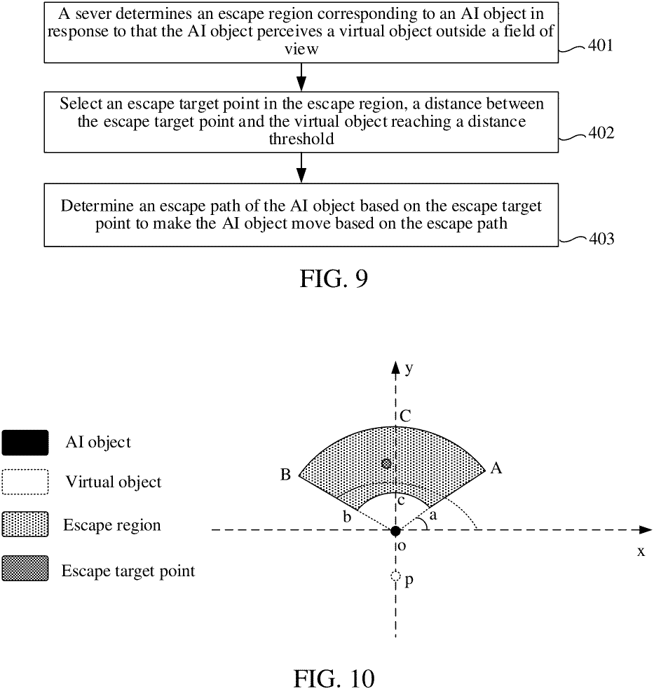

In some embodiments, after the AI object perceives the virtual object, the server may control the AI object away from the virtual object. Referring to FIG. 9, FIG. 9 is a diagram of a manner of an AI object being kept away from a virtual object provided by an embodiment of the present disclosure, which is illustrated in connection with the steps shown in FIG. 9.

Step 401: The server determines an escape region corresponding to the AI object in response to that the AI object perceives a virtual object outside the field of view.

In actual implementation, the AI object, when perceiving the virtual object outside the field of view, determines that an operation of escaping from the virtual object needs to be executed; the AI object needs to learn an escape region, and then sends a pathfinding request far from the virtual object to the server; the server receives the pathfinding request far from the virtual object sent by the AI object; and the server determines an escape region (an escape range) corresponding to the AI object in response to the pathfinding request. It needs to be explained that the escape region corresponding to the AI object belongs to a part of the current field of view of the AI object.

In some embodiments, the server may determine the escape region corresponding to the AI object according to the following manners: The server acquires a pathfinding mesh corresponding to the virtual scene, an escape distance corresponding to the AI object, and an escape direction relative to the virtual object. The server determines the escape region corresponding to the AI object based on the escape distance and the escape direction relative to the virtual object in the pathfinding mesh.

In actual implementation, the server loads pre-derived navmesh information to construct a pathfinding mesh corresponding to the virtual scene. The overall pathfinding mesh generation process may include: 1. voxelization of the virtual scene; 2. generation of a corresponding height field; 3. generation of a connected region; 4. generation of a region boundary; 5. generation of a polygon mesh to finally obtain a pathfinding mesh. Then, in the pathfinding mesh, the server determines the escape region corresponding to the AI object according to an escape distance preset by the AI object and an escape direction relative to the virtual object.

In some embodiments, the server may also determine the escape region corresponding to the AI object according to the following manners: The server determines a minimum escape distance, a maximum escape distance, a maximum escape angle, and a minimum escape angle corresponding to the AI object. The server constructs a first sector region along the escape direction relative to the virtual object with a position of the AI object in the virtual scene as a center of a circle, the minimum escape distance as a radius, and a difference between the maximum escape angle and the minimum escape angle as a central angle. The server constructs a second sector region along the escape direction relative to the virtual object with the position of the AI object in the virtual scene as a center of a circle, the maximum escape distance as a radius, and the difference between the maximum escape angle and the minimum escape angle as a central angle. The server determines a region within the second sector region that does not overlap with the first sector region as the escape region corresponding to the AI object.

In actual implementation, referring to FIG. 10, FIG. 10 is a diagram of an escape region of an AI object provided by an embodiment of the present disclosure. In the drawing, taking a position where the AI object is located as an origin O and an escape direction relative to a virtual object p as a y-axis direction (namely, a direction where a line segment formed by two points of po is located on an extension line and is away from P in the drawing), a coordinate system xoy is constructed, and a point c is selected on the extension line of po, so that when the AI object moves to the point c, it is just within a safe range, namely, the length of pc (po + pc) is equal to a preset escape threshold distance. That is, the circular region, defined by the position where the AI object is located as a center of a circle and the oc distance as the radius, is the maximum range of the AI object in the risk region. The server may determine the position where the point C is located as the maximum distance that the AI object may escape. The server determines the escape region of the AI object, namely, the AabB region in the drawing, according to the minimum escape distance oc (minDis), the maximum escape distance oC (maxDis), the minimum escape angle xoa (minAng), and the maximum escape angle xob (maxAng).

Step 402: Select an escape target point in the escape region, a distance between the escape target point and the virtual object reaching a distance threshold.

In actual implementation, after determining the escape region of the AI object, the server may randomly select a target point within the escape region as the escape target point of the AI object. Referring to FIG. 9, the server acquires a random point in the AabB region in the drawing as a target point; at the same time, to ensure that the random point has the property of uniform distribution, the random point may be determined according to the following formula, with the coordinate of the random point being (randomPosX, randomPosY):

$$\text{minRatio} = \text{sqrt} \left(\text{minDis}\right) / \text{sqrt} \left(\text{maxDis}\right) ;$$

$$\text{randomDis} = \text{maxDis} * \text{rand} \left(\text{minRatio, 1}\right) ;$$

$$\text{randomAngle} = \text{random} \left(\text{minAng, maxAng}\right) ;$$

$$\text{randomPosX=centerPosX+ randomDis * cos} \left(\text{randomAngle}\right) ;$$

$$\text{randomPosY=centerPosY + randomDis * sin} \left(\text{randomAngle}\right) ;$$

In the above formula, minRatio may be regarded as a random factor, the random factor being a number less than 1; randomDis may be regarded as the distance of the random point from the AI object; randomAngle may be regarded as the offset angle of the random point with respect to the AI object; and (centerPosX, centerPosY) may be regarded as the position of the AI object, and (randomPosX, randomPosY) being the coordinate of the random point.

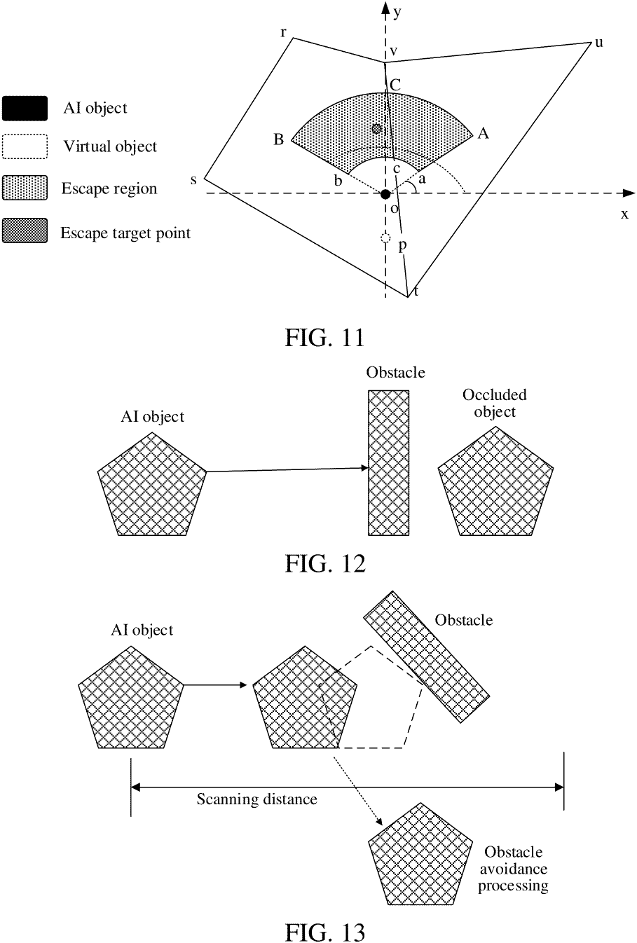

In actual implementation, after obtaining the escape target point of the AI object in the 2D region through the above mathematical calculation, the server needs to calculate the correct Z coordinate of the point in the 3D world (namely, projecting the escape target point to the 3D space) after obtaining the random point in the 2D region through mathematical calculation. Referring to FIG. 11, FIG. 11 is a diagram of a mesh polygon of an escape region provided by an embodiment of the present disclosure. The server acquires all 3D polygon meshes intersecting with the 2D region (a polygon rstv and a polygon tuv in the drawing), finds a polygon a random point located in a traversal form (the polygon rstv the random point located in the drawing), and then projects the random point on the polygon, the projected point being a correct position which can walk.

Step 403: Determine an escape path of the AI object based on the escape target point to make the AI object move based on the escape path.

In actual implementation, based on the position of the AI object and the determined escape target point, the server determines an escape path of the AI object using a relevant pathfinding algorithm and the like, and allocates the escape path to the current AI object, so that the AI object can move along the obtained escape path and escape the virtual object; the relevant pathfinding algorithm may be any one of an A* pathfinding algorithm, an ant colony algorithm, and the like.

Step 102: Control the AI object to move in the virtual scene based on the field of view.

In actual implementation, after determining the field of view of the AI object, it is equivalent to endowing the AI object with a visual field perception capability. The AI object may be controlled to perform activities, such as walking and running, based on the visual field perception capability. Referring to FIG. 5, the server may control the movement of the AI object in the virtual scene according to the determined field of view of the AI object.

Step 103: Perform collision detection of 3D space on a virtual environment where the AI object is located during movement of the AI object to obtain a detection result.

In actual application, considering that an obstacle may exist in the virtual scene and the obstacle occupies a certain volume in the virtual scene, the AI object needs to bypass the obstacle in encountering the obstacle during the movement in the virtual scene, namely, the position of the obstacle in the virtual scene is a position where the AI object is not accessible. The obstacle may be a stone, a wall, a tree, a tower, a building, and the like.

In some embodiments, the server may perform collision detection for the virtual environment 3D space in which the AI object is located by the following manners: The server controls the AI object to emit rays, and scans in a 3D space of an environment based on the emitted rays. The server receives a reflection result of the rays, and determines that the obstacle exists in a corresponding direction in response to the reflection result characterizing that one or more reflection lines of one or more rays of the emitted rays are received.

In actual implementation, the server needs, when controlling the AI object to move in the field of view, to detect in real time whether an obstacle exists in a virtual environment where the AI object is located. The obstacle may be a virtual object in the virtual scene which can hinder the AI object from traveling, such as a virtual mountain and a virtual river. The server may implement obstacle occlusion determination based on ray (raycast ray) detection by a physical computation engine (for example, PhysX). Referring to FIG. 12, FIG. 12 is a diagram of obstacle occlusion detection in a virtual scene provided by an embodiment of the present disclosure. For the virtual object in the field of view of the AI object, the server controls the AI object to send a ray from its own position to the position where the virtual object is located; object information intersecting with the ray is returned during ray detection. If the object is blocked by the obstacle, the obstacle information is returned, and the feature that the blocked object is invisible may be guaranteed based on ray detection.

Step 104: Control, in response to determining that an obstacle exists in a moving path of the AI object based on the detection result, the AI object to perform corresponding obstacle avoidance processing.

In some embodiments, the server may control the AI object to perform corresponding obstacle avoidance processing by the following manners: The server determines physical attributes and position information of the obstacle, and determines physical attributes of the AI object. The server controls the AI object to perform corresponding obstacle avoidance processing based on the physical attributes and position information of the obstacle and the physical attributes of the AI object.

In actual implementation, referring to FIG. 13, FIG. 13 is a diagram of an obstacle detection method in a virtual scene provided by an embodiment of the present disclosure. Based on sweep scanning of PhysX, the AI object may perceive in advance whether an obstacle will exist during movement. As shown in the drawing, the AI object checks whether there is an obstacle when moving in a specified direction and distance through sweep; and If there is an obstacle blocking, information such as the position of the blocking point will be obtained. In this way, the AI object may realize anthropomorphic obstacle avoidance processing in advance.

In some embodiments, the server may control the AI object to perform corresponding obstacle avoidance processing by the following manners: The server determines motion behaviors corresponding to avoiding the obstacle based on the physical attributes and position information of the obstacle and the physical attributes of the AI object. The server performs a corresponding kinematic simulation based on the determined motion behaviors to avoid the obstacle.

In actual implementation, the AI object may perform collision detection based on PhysX, the actor in PhysX may attach shape, the shape describing the spatial shape and collision properties of the actor. By adding the shape to the AI object for collision detection, it is possible to avoid the situation where the AI objects always block each other while moving; and when two AI objects block each other to generate a collision while moving, they may know this situation based on the collision detection and ensure the normal progress of the movement by bypassing and the like. In addition, the AI object may also perform kinematic simulation based on PhysX. In addition to shape, the actor in PhysX may also have a series of characteristics, such as mass, speed, inertia, and material (including friction coefficient). Through physical simulation, the motion of the AI object may be more realistic. For example, the AI object may perform collision detection to avoid the obstacle in advance. When the AI object walks in a cave, a squatting pass may be attempted if a standing cannot pass through the region but a squatting can pass.

The embodiments of the present disclosure enable the AI object to perform more realistically when moving in the virtual scene by providing the AI object with an anthropomorphic visual field perception based on a visual field distance and a visual field angle in a virtual scene created by a 3D physical simulation. At the same time, the AI object is given the ability to perceive the virtual object outside the field of view, to realize the authenticity of the AI object. According to the light environment of the virtual scene, the size of the field of view of the AI object may be adjusted dynamically to increase the sense of reality of the AI object. The AI object is also endowed with the physical perception ability of the 3D world, which conveniently realizes the simulation of the situations such as sight-line occlusion, movement obstruction, and collision detection in the 3D physical world, and provides the AI object with the automatic pathfinding ability based on the pathfinding mesh, enabling the AI object to automatically move and avoid obstacles in the virtual scene, avoiding the situation that the AI object collides with the movable character in the related art and causes the picture to get stuck, reducing the hardware resource consumption when the picture gets stuck, and improving the data processing efficiency and utilization rate of the hardware resource.

In the following, exemplary applications of the embodiments of the present disclosure in a practical application scene will be described.

Visual perception is the basis of environment perception in virtual scenes (for example, games). In 3D open-world games, a real AI object has an anthropomorphic visual perception range. However, in the related 3D open world, the visual perception mode of AI objects is relatively simple, which is generally divided into active perception and passive perception. Active perception is one based on a range determined by a distance, and when a player enters a perception range, the AI object is notified to perform a corresponding performance. Passive perception is when the AI object perceives a player after receiving interactive information from the player, such as fighting after being attacked by the player. The above visual field perception mode of AI objects is characterized by relatively simple principle and implementation, and good performance, and may be basically applied to visual field perception in a 3D open world. However, the disadvantages are also obvious, such as the field of view of AI objects is not anthropomorphic, there are a series of problems, such as visual field angle is not limited, the field of view is not adjusted based on the environment, and so on, which finally leads to the decrease of the immersive experience of players.

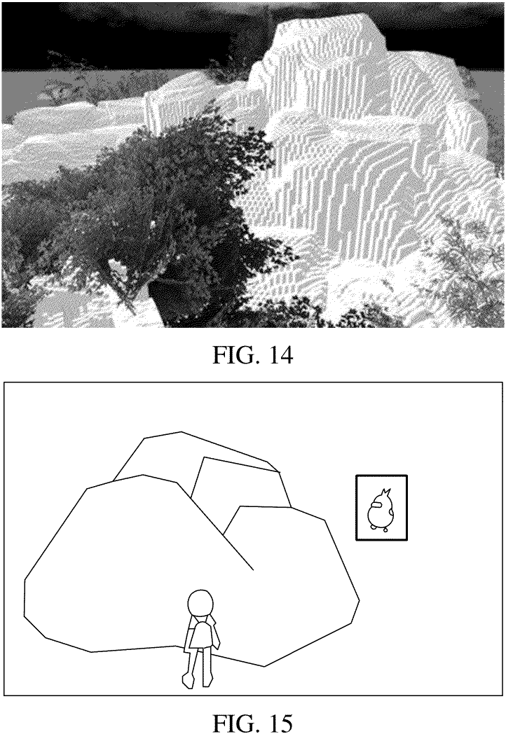

In order to construct a real environment perception system, the AI object needs to have a physical perception capability to the surrounding environment. In the relevant 3D open world, referring to FIG. 14, FIG. 14 is a voxelization diagram provided by the related art. The physical perception scheme of the AI object is mainly as follows: The first simple perception scheme is to perform two-dimension on the 3D game world, divide the 3D world into individual 2D mesh, and mark the height of Z coordinate and other information on the mesh to achieve a simple record of the 3D world. The second perception scheme is to use a layered 2D form to convert 3D terrain into a multi-layer walkable 2D walking layer, such as converting a simple house into a two-layer walking layer of the ground and the roof. The third perception scheme is to voxelize the 3D world with numerous AABB containment boxes and record 3D information from the voxels. Among the above 3D open world physical perception schemes, the simple two-dimension scheme is the easiest to realize and may be applied to most world scenes, but cannot be correctly processed for physical scenes such as tunnels and buildings. The layered 2D scheme may correctly handle the scenes with a plurality of walking layers such as tunnels and buildings, but for complex buildings, it is difficult to layer and the number of layers is too large. The 3D world voxelization scheme can restore the physical scene well, but if the voxel size is too large, it cannot restore the 3D world accurately; and if the voxel size is too small, it will lead to excessive memory occupation and affect the server performance.

In addition, in 3D open-world games, AI objects often have patrol, escape, and other behaviors, which requires AI objects to be aware of the terrain information of the surrounding environment. In the related 3D open world, there are two main schemes to find the AI objects: The first is to use a blocking graph for pathfinding, divide the 3D world into a mesh of a certain size (typically 0.5 m) and mark each mesh as standable or non-standable. Finally, based on the generated blocking binary image, A*, JPS, and other algorithms are used for pathfinding. The second is to voxelize the 3D world and perform pathfinding based on the voxelized information. In the above pathfinding schemes, whether using blocking graph or voxelization, if the mesh or voxel size is too small, it will lead to the problem that the memory occupation of the service end is too high and the pathfinding efficiency is too low. If the mesh or voxel size is too large, this leads to a problem of insufficient pathfinding accuracy. Furthermore, the relevant client engine uses navmesh pathfinding, and if the service end uses other pathfinding methods, there is a possibility that the pathfinding results of both sides are inconsistent. If the client determines from the navmesh that a certain position within the AI perception range can stand, after the player reaches the position, the AI object perceives the player and needs to fight nearly. However, the service end pathfinding scheme determines that the position is not standing and unable to find a way, which eventually leads to the problem that the AI object cannot reach this point fight.

Based on this, the embodiments of the present disclosure provide an object processing method in a virtual scene, and the method is also an environment perception scheme of a server end AI in a 3D open-world game, in which an anthropomorphic view management scheme will be used for the AI object, and a real 3D open world will be restored based on PhysX physical simulation. The server uses navmesh to realize undifferentiated navigation pathfinding with a client, which avoids many problems existing in the related art in design and implementation, and finally provides a good environment perception capability for the AI object.

First, an interface including an AI object and a player-controlled virtual object is presented through an application client supporting a virtual scene deployed by a terminal. In order to achieve the personification effect for an AI object provided by an embodiment of the present disclosure in an interface of a virtual scene, three effects need to be achieved.

Firstly, the authenticity of AI visual field perception is to be ensured, so that AI has an anthropomorphic field of view, meeting the rules mentioned in the summary of the invention point. Referring to FIG. 15, FIG. 15 is a diagram of visual field perception of an AI object provided by an embodiment of the present disclosure. As shown in the drawing, when a player hides behind an obstacle, the AI object is still imperceptible to the player even though the distance is close and in the front field of view of the AI object.

Secondly, the correctness of 3D open world physical perception is to be ensured. The physical world of the server needs a good restoration of the real scene, so that the AI object can correctly realize a series of behaviors based on this, for example, the AI object may perform collision detection in flight and avoid obstacles in advance. When the AI object walks in a cave, a squatting pass may be attempted if a standing cannot pass through the region but a squatting can pass.

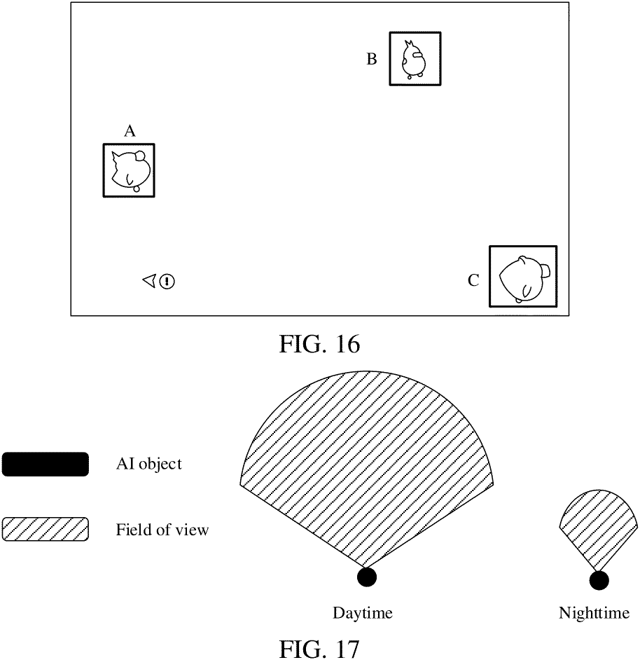

Thirdly, it is necessary to ensure that AI objects can automatically select target points in common scenes such as patrol and escape, and to select paths according to the target points. In addition, the selected target point is to be a reasonable walkable position, for example, the position under the cliff cannot be selected as the target point when the AI patrol on the cliff edge. At the same time, the path selected according to the target point is to be reasonable. Referring to FIG. 16, FIG. 16 is a diagram of AI object pathfinding provided by an embodiment of the present disclosure. As shown in the drawing, when moving from point A to point C, selecting a path with A-> C is more reasonable, and selecting a path with A-> B-> C is not reasonable.

For the above first point, when the service end realizes visual field perception for the AI object, the field of view of the AI object is controlled by two parameters, namely, a distance and an angle. As shown in FIG. 5, the sector region determined by the parameters of visual field distance and visual field angle is the visible region of the AI object. The virtual objects within the field of view and not occluded by the obstacle are visible, and the virtual objects outside the field of view are invisible. Illustratively, field of view parameters of 8000 cm and 120° may be employed, thus assuring anthropomorphic requirements of near-distance visibility, far-distance invisibility, front-view visibility, and back-view invisibility.

In actual implementation, for a virtual object (a player and the like) located within the field of view of the AI object, the virtual object is not to be visible if it is obscured by an obstacle. The embodiments of the present disclosure realize the determination of obstacle occlusion based on raycast ray detection of PhysX. As shown in FIG. 12, for an object in the field of view, AI will emit a ray from its own position to the position where the object is located; object information intersecting with the ray is returned during raycast ray detection. If the object is blocked by the obstacle, the obstacle information is returned, and the feature that the blocked object is invisible may be guaranteed based on ray detection.

In actual implementation, an anthropomorphic AI object is to be perceived, although invisible, for objects located outside the field of view of the AI object. As shown in FIG. 7, the server determines the perception region of the AI object based on the perception distance; when the object enters the perception region, the perception degree of the object will be increased over time; and the longer the time, the greater the perception degree. In addition, the increment rate of perception degree is also related to the moving speed of the object. When the object is stationary, the increment rate is minimum; when the moving speed of the object increases, the increment rate of perception degree will also increase. When the perception degree increases to a threshold, the AI object will perceive the object.

In actual implementation, a reasonable field of view of the AI object is not to be constant. The field of view of the AI object provided by the embodiments of the present disclosure may be dynamically adjusted as game time in the 3D world changes. Referring to FIG. 17, FIG. 17 is a diagram of changes in a field of view of an AI object provided by an embodiment of the present disclosure. As shown in the drawing, the field of view of the AI object is maximized during the day, gradually decreases as the night comes, and reaches a minimum at night.

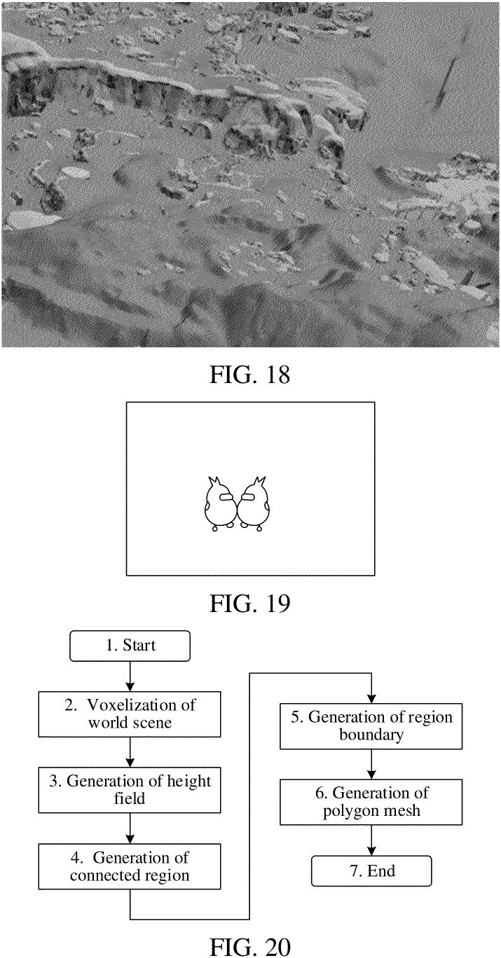

For the above second point, the service end realizes the physical perception simulation for the AI object based on PhysX. PhysX divides the 3D open world in a game into a plurality of scenes, each scene containing a plurality of actors. For terrain, buildings, trees, and other objects in the 3D world, PhysX will be simulated as a static rigid body of PxRigidStatic type. For players and AI objects, a dynamic rigid body of the PxRigidDynamic type is simulated. When the server end uses, it is necessary to first export a PhysX simulation result from a client as a xml file or a dat file which may be loaded by the server end before load and use. A 3D open world of the PhysX simulation is shown in FIG. 18; FIG. 18 is a diagram of PhysX simulation results provided by an example of the present disclosure.

In actual implementation, the AI object may perform correct physical perception based on the simulated 3D open world and through several methods (such as sweep scanning) provided by PhysX. Based on sweep scanning of PhysX, the AI object may perceive in advance whether there are obstacles during the movement. As shown in FIG. 13, the AI object checks whether there is an obstacle when moving in a specified direction and distance through sweep; and if there is an obstacle blocking, information such as the position of the blocking point will be obtained. In this way, the AI object may realize anthropomorphic obstacle avoidance processing in advance.

In actual implementation, the AI object may perform collision detection based on PhysX, the actor in PhysX may attach shape, the shape describing the spatial shape and collision properties of the actor. By adding shape to the AI object for collision detection, it is possible to avoid the situation that the AI objects shown in FIG. 19 (FIG. 19 is a diagram illustrating movement of AI objects to block each other provided by an embodiment of the present disclosure) always block each other while moving. When two AI objects block each other to generate a collision while moving, they may know this situation based on the collision detection and ensure the normal progress of the movement by bypassing and the like.

In actual implementation, the AI object may also perform kinematic simulation based on PhysX. In addition to shape, the actor in PhysX may also have a series of characteristics, such as mass, speed, inertia, and material (including friction coefficient). Through physical simulation, the motion of the AI object may be more realistic.

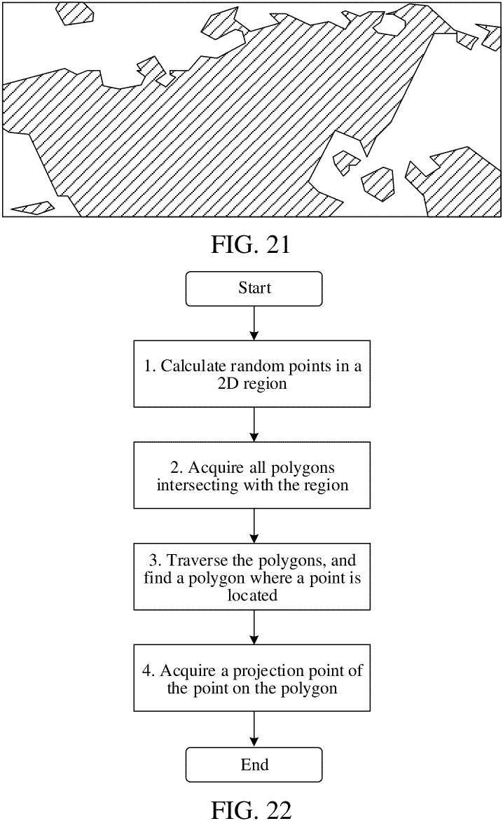

According to the above third point, automated pathfinding is a basic capability of AI objects, and AI objects need automated pathfinding in patrol, escape, chase, and obstacle avoidance scenes. The service end may implement pathfinding navigation of the AI object based on navmesh, and firstly a virtual scene in a 3D world needs to be exported as a polygon mesh used by the navmesh. Referring to FIG. 20, FIG. 20 is a flowchart for generating a navmesh corresponding to a virtual scene provided by an embodiment of the present disclosure. The process of the service end generating the navmesh corresponding to the virtual scene in the drawing is as follows: 1. The service end starts to execute a navmesh generation process. 2. Voxelization of a world scene. 3. Generation of a height field. 4. Generation of a connected region. 5. Generation of a region boundary. 6. Generation of a polygon mesh. 7. Generation of a navmesh corresponding to the virtual scene to end the navmesh generation process. Illustratively, referring to FIG. 21, FIG. 21 is a diagram of a navmesh provided by an embodiment of the present disclosure.

In actual implementation, when the server end uses, firstly, the derived navmesh information is loaded, and based on the navmesh information, the AI object realizes the correct selection (pathfinding) of a position in patrol and escape situations. When the AI object patrols, it is necessary to select a walkable position in a specified patrol region. When the AI object escapes, it is necessary to select an escape position within a specified escape range. In the related art, the navmesh only provides the ability to select points within a circular region and has low applicability in practical games.

Referring to FIG. 11, in FIG. 11, a random point is acquired in a 2D region limited by a maximum distance, a minimum distance, a maximum angle, and a minimum angle. To ensure that the random point has the property of uniform distribution, the random point may be determined according to the following formula, with the coordinates of the random point being (randomPosX, randomPosY):

$$\text{minRatio} = \text{sqrt} \left(\text{minDis}\right) / \text{sqrt} \left(\text{maxDis}\right) ;$$

$$\text{randomDis} = \text{maxDis * rand} \left(\text{minRatio, 1}\right) ;$$

$$\text{randomAngle} = \text{random} \left(\text{minAng, maxAng}\right) ;$$

$$\text{randomPosX=centerPosX+ randomDis * cos} \left(\text{randomAngle}\right) ;$$

$$\text{randomPosY=centerPosY + randomDis * sin} \left(\text{randomAngle}\right) ;$$

In the above formula, minRatio may be regarded as a random factor, the random factor being a number less than 1; randomDis may be regarded as the distance of the random point from the AI object; randomAngle may be regarded as the offset angle of the random point with respect to the AI object; and (centerPosX, centerPosY) may be regarded as the position of the AI object, and (randomPosX, randomPosY) being the coordinate of the random point.

Referring to FIG. 22, FIG. 22 is a flow diagram of a method for selecting points in a region provided by an embodiment of the present disclosure. The implementation process of selecting points in the region is as follows: 1. calculating random points in a 2D region; 2. acquiring all polygons intersecting with the region; 3. traversing the polygons, and finding a polygon where a point is located; 4. acquiring a projection point of the point on the polygon. In the embodiments of the present disclosure, after obtaining a random point in the 2D region through mathematical calculation, it is also necessary to calculate the correct Z coordinate of the point in the 3D world. The service end acquires all the 3D polygon meshes intersecting with the 2D region, finds a polygon a random point located in a traversal form, and then projects the random point on the polygon, the projection point being a correct position which can walk. Based on the selected target position, the AI object may obtain the best path from the current position to the target position through navmesh, and finally perform patrol, escape, or chase based on the path.

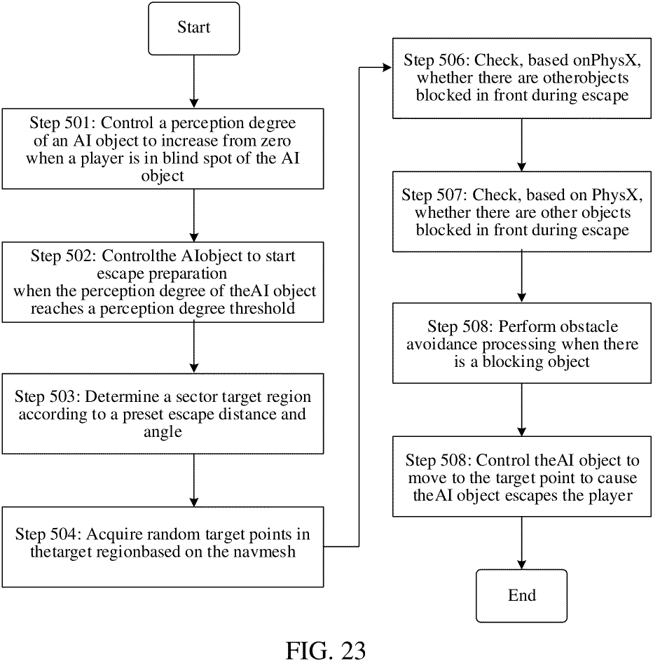

Based on visual perception, physical perception, and topographical perception, AI objects may be rendered more anthropomorphic. Illustratively, taking the case where the AI object is away from the player as an example, the overall flow of the object control method in the virtual scene provided by the embodiments of the present disclosure will be described. Referring to FIG. 23, FIG. 23 is a diagram of controlling an AI object to perform escape operations provided by an embodiment of the present disclosure. The following steps are performed. Step 501: Control the perception degree of the AI object to increase from zero when the player is in the blind spot of the AI object. Step 502: Control the AI object to start escape preparation when the perception degree of the AI object reaches the perception degree threshold. Step 503: Determine a sector target region according to a preset escape distance and angle. Step 504: Acquire random target points in the target region based on the navmesh. Step 505: Find a traversable path through the navmesh based on the current position and the template position. Step 506: Check, based on PhysX, whether there are other objects blocked in front during escape. Step 507: Perform obstacle avoidance processing when there is a blocking object. Step 508: Control the AI object to move to the target point to cause the AI object to escape the player.

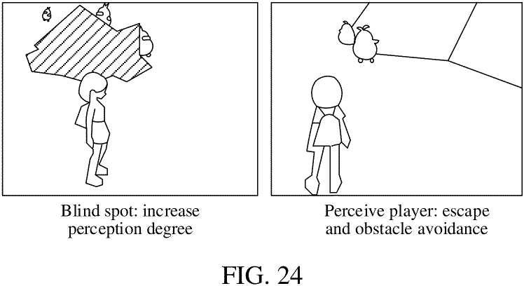

Illustratively, referring to FIG. 24, FIG. 24 is a diagram of performance of an AI object provided by an embodiment of the present disclosure. In the drawing, the player is in a blind spot of the AI object and the AI object does not see the player, but there is perception. After the perception degree increment reaches the perception degree threshold, the AI object perceives the player and is ready to escape. During escaping, the AI object firstly determines the target region of escaping based on the distance required to escape and the direction angle of escaping, and then selects the target point according to the method introduced in the forgoing automatic pathfinding based on the navmesh. After determining the target position, the AI object finds an optimal path from the current position to the target position through the navmesh and then starts to escape. In the process of escape, the AI object may be blocked by other AI objects. In this case, PhysX is to be used to achieve pre-obstacle avoidance, achieve effective escape, and finally reach the target position.

Application of the embodiments of the present disclosure may produce the following beneficial effects:

(1) In this paper, a distance-and-angle-based anthropomorphic visual field perception scheme is provided, as well as providing perception capability for the objects in the blind spot of the visual field. In addition, the objects blocked by obstacles are eliminated based on PhysX ray detection, realizing the anthropomorphic field of view of AI objects. At the same time, the size of the field of view of the AI object is dynamically adjusted based on the change of time in the game, increasing the sense of reality.

(2) Through the physical simulation of 3D open world by PhysX, the real game scene is restored accurately, so that AI objects have the ability of physical perception of the 3D world. In addition, through recast, sweep and other methods, the simulation of sight-line occlusion, movement obstruction, collision detection, and other situations in the physical world is easily realized.

(3) The AI object is provided with an automatic pathfinding capability based on the navmesh, so that the AI object may automatically select points in the specified region, and select the appropriate path based on the target points, and finally realize automatic patrol, escape, chase, and other scenes.

It is to be understood that in the embodiments of the present disclosure, relating to relevant data of user information and the like, user permission or consent needs to be obtained when the embodiments of the present disclosure are applied to products or technologies; and collection, use, and processing of the relevant data needs to comply with relevant laws and regulations and standards of relevant countries and regions.

The following continues to illustrate an exemplary structure of an object processing apparatus 555 in a virtual scene provided by the embodiments of the present disclosure implemented as a software module. In some embodiments, as shown in FIG. 2, a software module, stored in the object processing apparatus 555 in the virtual scene of a memory 550 may include:
a determination module 5551, configured to determine a field of view of an AI object in a virtual scene, the virtual scene being created by a 3D physical simulation;
a first control module 5552, configured to control movement of the AI object in the virtual scene based on the field of view;
a detection module 5553, configured to perform collision detection of 3D space on a virtual environment where the AI object is located during movement of the AI object to obtain a detection result; and
a second control module 5554, configured to control, in response to determining that an obstacle exists in a moving path of the AI object based on the detection result, the AI object to perform corresponding obstacle avoidance processing.

In some embodiments, the determination module is further configured to: acquire a visual field distance and a visual field angle of the AI object, the visual field angle being an acute angle or an obtuse angle; construct a sector region with a position of the AI object in the virtual scene as a center of a circle, the visual field distance as a radius, and the visual field angle as a central angle; and determine a region range corresponding to the sector region as the field of view of the AI object in the virtual scene.

In some embodiments, the determination module is further configured to: acquire a current light environment of the virtual environment where the AI object is located, different light environments having different brightness; and correspondingly adjust, in response to that the current light environment changes, the field of view of the AI object in the virtual scene during the movement of the AI object, a range of the field of view being positively correlated with the brightness of the current light environment.

In some embodiments, the determination module is further configured to: acquire a perception distance of the AI object; construct a circular region with a position of the AI object in the virtual scene as a center of a circle and the perception distance as a radius, and determine the circular region as a perception region of the AI object in the virtual scene; and control the AI object to perceive a virtual object in response to that the virtual object enters the perception region and is outside the field of view.

In some embodiments, the determination module is further configured to: acquire a duration that the virtual object has been in the perception region; and determine a perception degree of the AI object to the virtual object based on the duration, the perception degree being positively correlated with the duration.

In some embodiments, the determination module is further configured to: acquire a change rate of the perception degree with a change of the duration; acquire a moving speed of the virtual object in response to that the virtual object moves within the perception region; acquire, in response to that the moving speed of the virtual object changes, acceleration corresponding to the moving speed during movement of the virtual object; and adjust the change rate of the perception degree based on the acceleration corresponding to the moving speed.

In some embodiments, the determination module is further configured to: acquire a duration that the virtual object has been in the perception region, and determine a first perception degree of the AI object to the virtual object based on the duration; acquire a moving speed of the virtual object within the perception region, and determining a second perception degree of the AI object to the virtual object based on the moving speed; acquire a first weight corresponding to the first perception degree and a second weight corresponding to the second perception degree; and obtain a weighted sum of the first perception degree and the second perception degree based on the first weight and the second weight, to obtain a target perception degree of the AI object to the virtual object.

In some embodiments, the determination module is further configured to: acquire a distance between the virtual object and the AI object in the perception region; and determine a perception degree of the AI object to the virtual object based on the distance, the perception degree being positively correlated with the distance.

In some embodiments, the determination module is further configured to: determine an escape region corresponding to the AI object in response to that the AI object perceives a virtual object outside the field of view; select an escape target point in the escape region, a distance between the escape target point and the virtual object reaching a distance threshold; and determine an escape path for the AI object based on the escape target point to make the AI object to move based on the escape path.

In some embodiments, the determination module is further configured to: acquire a pathfinding mesh corresponding to the virtual scene, an escape distance corresponding to the AI object, and an escape direction relative to the virtual object; and determine the escape region corresponding to the AI object based on the escape distance and the escape direction relative to the virtual object in the pathfinding mesh.

In some embodiments, the determination module is further configured to: determine a minimum escape distance, a maximum escape distance, a maximum escape angle, and a minimum escape angle corresponding to the AI object; construct a first sector region along the escape direction relative to the virtual object with a position of the AI object in the virtual scene as a center of a circle, the minimum escape distance as a radius, and a difference between the maximum escape angle and the minimum escape angle as a central angle; construct a second sector region along the escape direction relative to the virtual object with the position of the AI object in the virtual scene as a center of a circle, the maximum escape distance as a radius, and the difference between the maximum escape angle and the minimum escape angle as a central angle; and take other regions of the second sector region not including the first sector region as the escape region corresponding to the AI object.

In some embodiments, the detection module is further configured to: control the AI object to emit rays, and scan in a 3D space of an environment based on the emitted rays; and receive a reflection result of the rays, and determine that the obstacle exists in a corresponding direction in response to the reflection result characterizing that one or more reflection lines of one or more rays of the emitted rays are received.

In some embodiments, the second control module is further configured to: determine physical attributes and position information of the obstacle, and determining physical attributes of the AI object; and control the AI object to perform corresponding obstacle avoidance processing based on the physical attributes and position information of the obstacle and the physical attributes of the AI object.

In some embodiments, the second control module is further configured to: determine motion behaviors corresponding to avoiding the obstacle based on the physical attributes and position information of the obstacle and the physical attributes of the AI object; and perform a corresponding kinematic simulation based on the determined motion behaviors to avoid the obstacle.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The embodiments of the present disclosure provide a computer program product or computer program including computer instructions, the computer instructions being stored in a computer-readable storage medium. A processor of a computer device reads the computer instructions from the computer-readable storage medium, and the processor executes the computer instructions to cause the computer device to execute the object processing method in a virtual scene described above in the embodiments of the present disclosure.

The embodiments of the present disclosure provide a computer-readable storage medium storing therein executable instructions. The executable instructions, when executed by a processor, implement the object processing method in a virtual scene provided by the embodiments of the present disclosure, for example, the object processing method in a virtual scene illustrated in FIG. 3.

In some embodiments, the computer-readable storage medium may be random-access memory (RAM), static random-access memory (SRAM), programmable read-only memory (PROM), read-only memory (ROM), electrically erasable programmable read-only memory (EEPROM), flash memory, magnetic surface memory, optical disk, or compact disc read-only memory (CD-ROM), and the like. various devices including one or any combination of the above memories.

In some embodiments, the executable instructions may be written in any form of program, software, software module, script, or code, in any form of programming language, including compiled or interpreted languages, or declarative or procedural languages. They may be deployed in any form, including as stand-alone programs or as modules, assemblies, subroutines, or other units suitable for use in a computing environment.

As an example, the executable instructions may, but need not, correspond to files in a file system, may be stored in a portion of a file that holds other programs or data, for example, in one or more scripts in a hyper text markup language (HTML) document, in a single file dedicated to the program in question, or in multiple coordinated files (for example, files storing one or more modules, subroutines, or portions of code).

As an example, the executable instructions may be deployed to be executed on one computer device, or on a plurality of computer devices located at one site, or on a plurality of computer devices distributed across a plurality of sites and interconnected by a communication network.

In summary, in the embodiments of the present disclosure, an anthropomorphic visual field perception range is given to the AI object, a real physical simulation of a game world is realized through PhysX, and automatic pathfinding of the AI object is realized using navmesh, and finally a mature AI environment perception system is constituted. Environment perception is the basis for the AI object to perform decisions, which enables the AI object to have a good perception of the surrounding environment, and ultimately make reasonable decisions, improving immersive experience of players in 3D open-world games.

The above is only embodiments of the present disclosure and is not intended to limit the scope of protection of the present disclosure. Any modification, equivalent replacement, improvement, and the like made within the spirit and scope of the present disclosure are to be included in the scope of protection of the present disclosure.

What is claimed is:

1. An object processing method in a virtual scene executed by an electronic device, the method comprising:
determining a field of view of an artificial intelligence (AI) object in the virtual scene;
controlling the AI object to move in the virtual scene based on the field of view;
performing collision detection of three-dimensional (3D) space on a virtual environment where the AI object is located during movement of the AI object to obtain a detection result; and
controlling, in response to determining that an obstacle exists in a moving path of the AI object based on the detection result, the AI object to avoid the obstacle.

2. The method according to claim 1, wherein the determining a field of view of an AI object in the virtual scene comprises:
acquiring a visual field distance and a visual field angle of the AI object, the visual field angle being an acute angle or an obtuse angle;
constructing a sector region with a position of the AI object in the virtual scene as a center of a circle, the visual field distance as a radius, and the visual field angle as a central angle; and
determining a region range corresponding to the sector region as the field of view of the AI object in the virtual scene.

3. The method according to claim 1, further comprising:
acquiring a current light environment of the virtual environment where the AI object is located, wherein different light environments have different brightness; and
correspondingly adjusting, in response to that the current light environment changes, the field of view of the AI object in the virtual scene during the movement of the AI object,
a range of the field of view being positively correlated with the brightness of the current light environment.

4. The method according to claim 1, further comprising:
acquiring a perception distance of the AI object;
constructing a circular region with a position of the AI object in the virtual scene as a center of a circle and the perception distance as a radius, and determining the circular region as a perception region of the AI object in the virtual scene; and
controlling the AI object to perceive a virtual object in response to that the virtual object enters the perception region and is outside the field of view.

5. The method according to claim 4, further comprising:
acquiring a duration that the virtual object has been in the perception region; and
determining a perception degree of the AI object to the virtual object based on the duration, the perception degree being positively correlated with the duration.

6. The method according to claim 5, further comprising:
acquiring a change rate of the perception degree with respect to a change of the duration;
acquiring a moving speed of the virtual object in response to that the virtual object moves within the perception region;
acquiring, in response to that the moving speed of the virtual object changes, acceleration corresponding to the moving speed during the movement of the virtual object; and
adjusting the change rate of the perception degree based on the acceleration corresponding to the moving speed.

7. The method according to claim 4, further comprising:
acquiring a duration that the virtual object has been in the perception region, and determining a first perception degree of the AI object to the virtual object based on the duration;
acquiring a moving speed of the virtual object within the perception region, and determining a second perception degree of the AI object to the virtual object based on the moving speed;
acquiring a first weight corresponding to the first perception degree and a second weight corresponding to the second perception degree; and
obtaining a weighted sum of the first perception degree and the second perception degree based on the first weight and the second weight, to obtain a target perception degree of the AI object to the virtual object.

8. The method according to claim 4, further comprising:
acquiring a distance between the virtual object and the AI object in the perception region; and
determining a perception degree of the AI object to the virtual object based on the distance, the perception degree being positively correlated with the distance.

9. The method according to claim 1, further comprising:
determining an escape region corresponding to the AI object in response to that the AI object perceives a virtual object outside the field of view;
selecting an escape target point in the escape region, a distance between the escape target point and the virtual object reaching a distance threshold; and
determining an escape path of the AI object based on the escape target point, and controlling the AI object to move based on the escape path.

10. The method according to claim 9, wherein the determining an escape region corresponding to the AI object comprises:
acquiring a pathfinding mesh corresponding to the virtual scene, an escape distance corresponding to the AI object, and an escape direction relative to the virtual object; and
determining the escape region corresponding to the AI object based on the escape distance and the escape direction relative to the virtual object in the pathfinding mesh.

11. The method according to claim 10, wherein the determining the escape region corresponding to the AI object based on the escape distance and the escape direction relative to the virtual object comprises:
determining a minimum escape distance, a maximum escape distance, a maximum escape angle, and a minimum escape angle corresponding to the AI object;
constructing a first sector region along the escape direction relative to the virtual object with a position of the AI object in the virtual scene as a center of a circle, the minimum escape distance as a radius, and a difference between the maximum escape angle and the minimum escape angle as a central angle;
constructing a second sector region along the escape direction relative to the virtual object with the position of the AI object in the virtual scene as a center of a circle, the maximum escape distance as a radius, and the difference between the maximum escape angle and the minimum escape angle as a central angle; and
determining a region within the second sector region that does not overlap with the first sector region as the escape region corresponding to the AI object.

12. The method according to claim 1, wherein the performing collision detection of 3D space on a virtual environment where the AI object is located to obtain a detection result comprises:
controlling the AI object to emit rays, and scanning in a 3D space of an environment based on the emitted rays; and
receiving a reflection result of the rays, and determining that the obstacle exists in a corresponding direction in response to the reflection result characterizing that one or more reflection lines of one or more rays of the emitted rays are received.

13. The method according to claim 1, wherein the virtual scene is created by a 3D physical simulation, and the controlling, in response to determining that an obstacle exists in a moving path of the AI object based on the detection result, the AI object to avoid the obstacle comprises:
determining physical attributes and position information of the obstacle, and determining physical attributes of the AI object; and
controlling the AI object to avoid the obstacle based on the physical attributes and position information of the obstacle and the physical attributes of the AI object.

14. The method according to claim 13, wherein the controlling the AI object to avoid the obstacle based on the physical attributes and position information of the obstacle and the physical attributes of the AI object comprises:
determining a motion behavior corresponding to avoiding the obstacle based on the physical attributes and position information of the obstacle and the physical attributes of the AI object; and
performing a corresponding kinematic simulation based on the determined motion behavior to avoid the obstacle.

15. An object processing apparatus in a virtual scene, the apparatus comprising:
at least one memory, configured to store executable instructions; and
at least one processor, configured to, when executing the executable instructions stored in the at least one memory, implement:
determining a field of view of an artificial intelligence (AI) object in the virtual scene;
controlling the AI object to move in the virtual scene based on the field of view;
performing collision detection of three-dimensional (3D) space on a virtual environment where the AI object is located during movement of the AI object to obtain a detection result; and
controlling, in response to determining that an obstacle exists in a moving path of the AI object based on the detection result, the AI object to avoid the obstacle.

16. The apparatus according to claim 15, wherein the determining a field of view of an AI object in the virtual scene comprises:
acquiring a visual field distance and a visual field angle of the AI object, the visual field angle being an acute angle or an obtuse angle;
constructing a sector region with a position of the AI object in the virtual scene as a center of a circle, the visual field distance as a radius, and the visual field angle as a central angle; and
determining a region range corresponding to the sector region as the field of view of the AI object in the virtual scene.

17. The apparatus according to claim 15, wherein the at least one processor is further configured to implement:
acquiring a current light environment of the virtual environment where the AI object is located, wherein different light environments have different brightness; and
correspondingly adjusting, in response to that the current light environment changes, the field of view of the AI object in the virtual scene during the movement of the AI object,
a range of the field of view being positively correlated with the brightness of the current light environment.

18. The apparatus according to claim 15, wherein the at least one processor is further configured to implement:
acquiring a perception distance of the AI object;
constructing a circular region with a position of the AI object in the virtual scene as a center of a circle and the perception distance as a radius, and determining the circular region as a perception region of the AI object in the virtual scene; and
controlling the AI object to perceive a virtual object in response to that the virtual object enters the perception region and is outside the field of view.

19. The apparatus according to claim 18, wherein the at least one processor is further configured to implement:
acquiring a duration that the virtual object has been in the perception region; and
determining a perception degree of the AI object to the virtual object based on the duration, the perception degree being positively correlated with the duration.

20. A non-transitory computer-readable storage medium storing executable instructions, the executable instructions, when executed by at least one processor, implementing:
determining a field of view of an artificial intelligence (AI) object in the virtual scene;
controlling the AI object to move in the virtual scene based on the field of view;
performing collision detection of three-dimensional (3D) space on a virtual environment where the AI object is located during movement of the AI object to obtain a detection result; and
controlling, in response to determining that an obstacle exists in a moving path of the AI object based on the detection result, the AI object to avoid the obstacle.
